(19) United States
(12) Patent Application Publication
(10) Pub. No.: US 2014/0309785 A1
(43) Pub. Date: Oct. 16, 2014

(54) Controller for Operation of an Actuator

(71) Applicant: ZF Friedrichshafen AG, Friedrichshafen (DE)

(72) Inventor: Sven Scheurer, Immenstaad (DE)

(73) Assignee: ZF Friedrichshafen AG, Friedrichshafen (DE)

(21) Appl. No.: 14/249,664

(22) Filed: Apr. 10, 2014

(30) Foreign Application Priority Data
Apr. 11, 2013 (DE) 10 2013 206 440.3

(51) Int. Cl. G05B 15/02

(52) U.S. Cl. CPC G05B 15/02
USPC 700/275

(57) ABSTRACT

A control unit for operating an actuator has at least one reception device for receiving a first target value (REQ) for the actuator, an information storage for storing at least one second target value (TGT) and one third target value (MEM) for the actuator, an issuing device for issuing the stored second target value (TGT) to the actuator, a counter for determining, in a step A, whether a time period has expired, a comparing device for comparing, in a step B, the first target value (REQ) received by the receiving unit with the third target value (TGT) stored in the information storage. If it is determined in step A that the time period has not yet expired, and if it is determined in step B that the first target value (REQ) does not correspond to the stored third target value (MEM), in a step C, the value of the second target value (TGT) is stored in the information storage as the third target value (MEM), and the value of the first target value (REQ) is stored in the information storage as the second target value (TGT).

### FIELD OF THE INVENTION

The invention relates to a control unit for operating an actuator, particularly in a transmission control unit, as well as a transmission and a vehicle control system incorporating least one such control unit.

### BACKGROUND

With systems that consist of at least two control units communicating with each other, which are mutually synchronized for certain information, there are situations in which an unwanted, constantly recurring fluctuation (toggle) of the information arises in the control units. This is due to the fact that, as caused by signal runtimes, signal cycle times and signal debouncing, the fed back information is no longer current at the point in time of processing in one of the control units.

From EP 0 701 515 B1, a method for synchronizing updated data between control units is known

For a commercial vehicle, it is known that a superordinate vehicle control unit is synchronized with a subordinate transmission control unit. Thereby, the vehicle control unit issues specifications (target values) of a vehicle operator, which it receives through a shift lever on the transmission control unit. Depending on the specifications (target values), the transmission control unit then controls a transmission actuator, which correspondingly shifts the vehicle transmission. This may be, for example, a reverse gear or an idle state or one of several forward gears (transmission stages). When synchronizing control units, the issued target values are cyclically exchanged with each other and, if necessary, aligned with each other.

Thereby, upon a direct specification of a transmission stage from the vehicle control unit to the transmission control unit, it may occur that an unwanted, recurring fluctuation to each of the issued target values is applied between the two control units. For the duration of this recurring fluctuation, no shifting of the transmission may be conducted and, if applicable, an ongoing shifting cannot be terminated.

### SUMMARY OF THE INVENTION

As such, a task of the invention is to provide a control unit for operating an actuator, with which, as caused by synchronization, an unwanted, constantly recurring fluctuation of the issued target value less frequently arises. Additional objects and advantages of the invention will be set forth in part in the following description, or may be obvious from the description, or may be learned through practice of the invention.

The tasks are solved by a control unit with the characteristics as claimed herein. Preferred embodiments thereof may be derived from the following description.

The invention also includes a transmission control unit that is designed in a manner corresponding to the control unit in accordance with the invention, along with a transmission and a vehicle control system, each equipped with such a control unit in accordance with the invention.

Accordingly, the invention is a control unit for operating an actuator. The control unit features at least one reception device for receiving a first target value for the actuator, along with an information storage for storing at least one second target value and one third target value for the actuator, along with an issuing device for issuing the stored second target value to the actuator. The control unit also has a counter for, in a step A, determining whether a time period has expired, and a comparing device for comparing the first target value received from the receiving device with the third target value stored in the information storage in a step B.

As part of step A, it is thus determined whether and, if applicable, to what extent the time period has expired. As part of step B, it is thus determined whether and, if applicable, to what extent the received first target value corresponds to stored third target value.

The first target value comprises in particular a desired new target value for the actuator, thus a value or a state that the actuator should take in the future.

The second target value comprises in particular a current target value, thus a value or a state that the actuator currently takes or is in the act of being taken from the actuator, or at least is currently being issued by the control unit for the actuator. The third target value comprises in particular an immediately preceding target value, thus a value or a state that the actuator took or that was in the act of being taken, before it took the current value or a state (the second target value) or is in the act of taking. The time period comprises a given time value, which, for example, is likewise permanently stored in the information storage, or is determined in operation on the basis of characteristics or formulas. The time period may be determined, in particular, on an empirical basis in advance. Based on experience, it is preferably less than 1 second, for example 0.5 seconds. The time period expires in the counter, and begins to run again upon restarting the counter. Of course, any method for determining whether a time period has expired, for example, a countdown or a comparison between a start time and a current time, may be used here.

The control unit is designed in such a manner that, if it is determined in step A that the time period has not yet expired, and it is also determined in step B that the first target value does not correspond to the stored third target value (thus, the first target value is not equal to the stored third target value), then, in a step C, the value of the second target value is stored in the information storage as the (new) third target value, and the value of the first target value is stored in the information storage as the (new) second target value.

Thus, a fluctuation of the second target value issued to the actuator through the issuing device takes place only if the conditions checked in steps A and B are met. Since the target value issued to the actuator is at the same time also that value with which a possibly existing second control unit synchronizes, through the inevitable checking of the specified conditions, unwanted, constant fluctuations much less frequently arise. Within the time period, an unwanted permanent fluctuation in the control unit is eliminated altogether.

Preferably, the comparing device, in addition to comparing the first target value with the second target value stored in the information storage, is designed in a step D, whereas the control unit is designed in such a manner that step C is carried out only if it was previously determined in step D that the first target value does not correspond to the stored second target value, thus if there is a deviation between the first and the second target value. This prevents unnecessary memory and arithmetic operations from being conducted in the control unit if the first and second target values are identical. In addition, a permanent unwanted constant fluctuation in the control unit may be prevented.

The chronological sequence for conducting steps A and B and, if applicable, step D is freely interchangeable with each step. In other words, prior to conducting step C, for example, initially step D and then step A and then step B may take place, or initially step B prior to step A and then step D may take place, etc. However, it has proved advantageous if, initially, step A, then step B and then, if applicable, step D are carried out before step C is finally carried out.

Preferably, the control unit is also designed in such a manner that, in a step E, which in particular immediately follows step C in the time sequence, the issuing device issues the second target value to the actuator. In addition, preferably in a step F, which in particular immediately follows steps C or E in the time sequence, the counter restarts. In all other respects, in the time sequence, step F may also take place immediately prior to or at the same time as steps C or E.

It is expedient that, if it is determined in step A that the time period has already expired, step C is carried out. In order to determine whether a change to the stored target value is at all necessary, and in order to prevent a permanent unwanted fluctuation of the second target value, step D may be carried out after conducting step C, and only if it is actually determined that the first target value does not correspond to the stored second target value will step C take place.

In an additional form, the control unit features a device for determining, in a step G, whether the first target value corresponds to an exception value, whereas if the device then determines that the target value corresponds to the first exception value, step C is carried out, in particular immediately afterwards in the time sequence. Likewise here, step D may initially take place prior to conducting step C, in order to determine whether a change to the stored target value is at all necessary. This is only the case if the first target value does not correspond to the stored second target value. As a general rule, one or more exception values may be provided.

By providing one or more exception values, prioritized shifting states of the actuator (target values) may be defined; these are immediately issued to the actuator. These may comprise, for example, states that are to be applied in the case of emergency. If the control unit is used as a transmission control unit, such an exception value may in particular comprise a target value for the actuator, through which it applies a transmission idle or through which it changes from a forward gear of the transmission to a reverse gear, or vice versa.

In an additional form, the control unit features a device for determining, in a step H, whether the target value received by the reception device has changed, for example whether the state of the signal for the first target value has changed. This may take place, for example, through the detection of a signal edge in the signal for the first target value. The control unit is then designed in such a manner that at least step A and/or step B and/or step D and/or step G is/are carried out only if the device determines a change to the first target value. This saves computing power in the control unit, as queries need not be constantly performed in steps A, B, D and/or G.

Preferably, the described control unit in accordance with the invention is a transmission control unit. Thereby, each of the first, second and third target values corresponds to a shifting state of a transmission controlled in operation by the transmission control unit, or a shift position of the actuator that causes the corresponding shifting state of the transmission. If the control unit is designed for a multi-stage vehicle transmission, the target value therefore comprises, for example, a specific gear or transmission stage, such as a “reverse gear,” “idle state,” “first forward gear,” “second forward gear,” etc. For other types of transmissions, for example lockable differential transmissions, the target value comprises a correspondingly different transmission-specific command, such as, for example, “lock differential” or “unlock differential.”

The invention also includes a transmission with at least the transmission control unit described above and a transmission actuator, which is designed in such a manner that it brings the transmission into a shifting state that corresponds to the second target value issued by the transmission control unit.

The invention also includes a vehicle control system with at least one first control unit, which is designed in accordance with the invention as described above, and with a second control unit, which is designed to convert a specification of a vehicle operator into a target value that corresponds to the specification of the vehicle operator, and issue such target value, as defined by the first target value, to the first control unit. Thereby, it is preferably provided that the first and the second control units are designed in such a manner that each of the issued target values are synchronized with each other. Thereby, the measures provided and explained for the first control unit reduce the risk of an unwanted, constant fluctuation of the target values that are synchronized with each other.

In a preferred version thereof, the second control unit is a vehicle control unit, which is connected to an electronic shift lever belonging to the vehicle control system, through which the vehicle operator may specify a desired transmission stage for a multi-stage vehicle transmission. Thereby, the second control unit converts the desired transmission stage into a target value, and issues this as defined by the first target value to the first control unit, when is then designed as a transmission control unit for controlling a vehicle transmission. Thereby, the second control unit is synchronized in particular with the second target value of the first control unit.

### BRIEF DESCRIPTION OF THE DRAWINGS

In the following, the invention is more described in greater detail through examples and drawings, from which additional advantageous arrangements and characteristics of the invention may be derived. The following are shown, each in schematic presentation:

FIG. 1 is a control unit;

FIG. 2 is a vehicle control system for a vehicle drive train;

FIG. 3 a flow chart of the steps involved in a control unit in accordance with FIG. 1.

### DETAILED DESCRIPTION

Reference will now be made to embodiments of the invention, one or more examples of which are shown in the drawings. Each embodiment is provided by way of explanation of the invention, and not as a limitation of the invention. For example features illustrated or described as part of one embodiment can be combined with another embodiment to yield still another embodiment. It is intended that the present invention include these and other modifications and variations to the embodiments described herein.

In the figures, equivalent or at least functionally equivalent components are provided with the same reference signs.

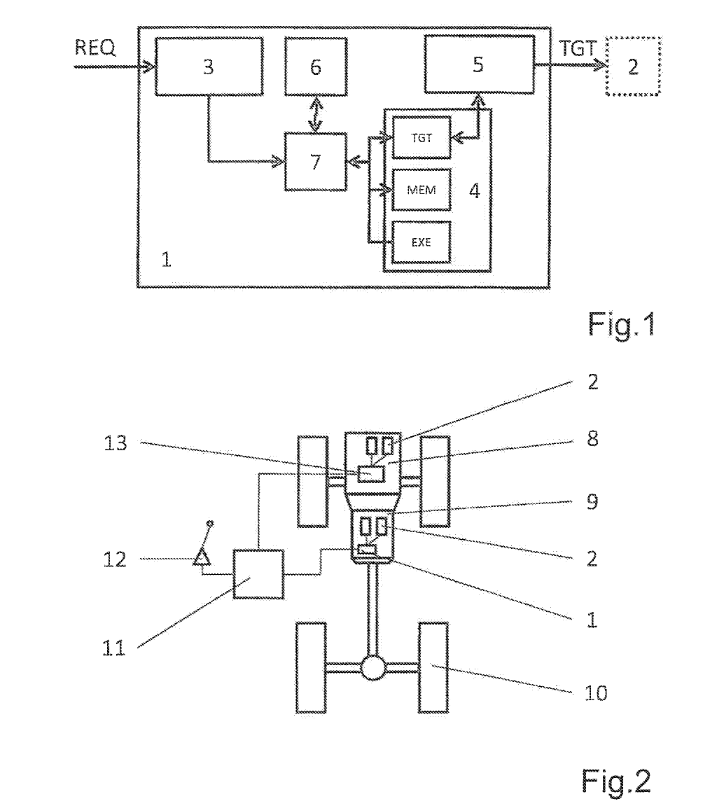

FIG. 1 shows a control unit 1 in accordance with the invention for operating an actuator 2. The control unit 1 has a reception device 3 for receiving a first target value REQ for the actuator 2 and an information storage 4 for storing at least one second target value TGT and a third target value MEM for the actuator 2. The first target value REQ is a newly requested target value, thus a target value, that is to be provided to the actuator 2 in the immediate future. The second target value TGT is a target value issued currently to the actuator, thus a target value that is in the act of being applied to the actuator 2, or is applied by the actuator 2. Moreover, the third target value MEM is an immediately previous target value, thus a target value that was issued immediately prior to the second target value TGT to the actuator 2. For issuing the second target value TGT to the actuator 2, the control unit 1 also features an issuing device 5. It also features a comparing device 7 and a counter 6. The counter 6 may determine whether and, if applicable, to what extent a time period has expired since a restarting of the counter 6. The time period is fixed, or dynamically determined based on given parameters and/or characteristics and/or formulas. The time period, or the characteristics or formulas required for the determination, may be stored in the information storage 4.

The comparing device 7 may determine whether and, if applicable, how the first target value REQ corresponds to the stored third target value MEM. In addition, the comparing device 7 may determine whether and, if applicable, to what extent the first target value REQ corresponds to the stored second target value TGT.

The reception device 3 and issuing device 5 may comprise, for example, a data bus interface. The information storage may comprise, for example, a digital storage. This may be carried out on a non-permanent or permanent basis.

As a general rule, the control unit 1 may serve as a control for the actuator 2, whereas this issues the target value TGT solely to the actuator 2, without checking whether this actually sets the value. Or, as a general rule, the control unit 1 may serve as a control for the actuator 2, whereas this detects the actual value attached to the actuator 2, and readjusts this as long as the actual value corresponds to the required target value TGT.

The control unit 1 is designed in such a manner that it stores the currently stored value of the second target value TGT as a new third target value MEM in the information storage 4 (and thereby overrides the prior target value MEM or archives it in a history), and stores the received value of the first target value REQ as a new second target value TGT in the information storage 4 (and thereby overrides the prior target value TGT or archives it in a history), if at least the following two conditions are met together. It must first be determined that the time period in the counter 6 has not yet expired, and secondly it must be determined that the first target value REQ does not correspond (thus, is not equivalent) to the stored third target value MEM. Accordingly, the control unit is designed to make these determinations.

In the exemplary version shown in FIG. 1, the first target value REQ is received from the reception device 3, and forwarded to the comparing device 7. The comparing device 7 then checks at least whether the first target value REQ is not equivalent to the stored third target value MEM, or whether there are at least sufficiently large differences between them. The counter 6 then checks whether the time period has expired, and forwards the results of the check to the comparing device 7. These checks may take place in parallel, or in any order one behind the other. If it is clear that the first target value REQ does not correspond to the stored third target value MEM and the time period has not yet expired, the comparing device 7 stores the value of the second target value TGT as a new third target value MEM in the information storage 4. In addition, the comparing device 7 then stores the value of the first target value REQ as a new second target value TGT in the information storage 4. The newly stored second target value TGT is forwarded from the information storage 4 to the issuing device 5. From there, it arrives at the actuator 2 outside of the control unit 1, which takes the respective shift position or the corresponding state to the actuator. Accordingly, the actuator 2 always receives only the second target value TGT stored in the information storage 4. In addition, the counter 6 then preferably restarts; i.e. the time period begins to run out again.

It may be optionally provided that the comparing device 7 or another device of the control unit 1 also checks whether the first target value REQ corresponds to the stored second target value TGT, and ultimately changes this only if the target values REQ, TGT are not equivalent. Thus, if the target values REQ, TGT are equivalent, unnecessary memory and arithmetic operations in the control unit 1 are avoided. In addition, a permanent, unwanted fluctuation of the issued second target value TGT can be prevented.

It may also be optionally provided that the comparing device 7 or another device of the control unit 1 is first checked for whether a change to the first target value REQ has taken place, and that the steps described above only take place if a change is actually present. Thus, if there was no change to the target values REQ, unnecessary memory and arithmetic operations in the control unit 1 are avoided.

It may also be optionally provided that the comparing device 7 or another device of the control unit 1 checks whether the first target value REQ corresponds to an exception value EXE. If this is the case, it may then be provided that the comparing device 7 or the other device of the control unit 1 stores the value of the second target value TGT, immediately or after additional checks, as a new third target value MEM in the information storage 4. In addition, the comparing device 7 or the other device of the control unit 1 then, immediately or after additional checks, stores the value of the first target value REQ, thus the exception value EXE, as a new target value TGT in the information storage 4. Which values represent exception values EXE may be permanently stored in the information storage 4 (as presented in FIG. 1) or dynamically determined, for example by means of characteristics and/or formulas.

It may be optionally provided that, if it is determined that the time period in the counter 6 has already expired, the comparing device 7 or another device of the control unit 1 stores the value of the second target value TGT, immediately or after additional checks, as a new third target value MEM in the information storage 4. In addition, the comparing device 7 or the other device of the control unit 1 then stores, immediately or after further checks, the value of the first target value REQ as a new second target value TGT in the information storage 4.

FIG. 2 shows a top view of a vehicle drive train, which is equipped with a vehicle control system in accordance with the invention.

The drive train has a drive motor 8, for example, an internal combustion engine and/or an electric motor, a vehicle transmission 9 and vehicle wheels 10, which are connected in a known manner by means of drive technology to the vehicle transmission 9 through drive shafts, and are thereby driven by the drive motor 8. The vehicle comprises in particular a personal vehicle or a truck. The drive motor 8 is driven, in the sense of being controlled or governed, by an engine control unit 13. The engine control unit 13 is in particular a part of the vehicle control system. Through the engine control unit 13, actuators 2 of the drive motor 8 are driven, in the sense of being controlled or governed, which undertake the adjustments necessary for the provision of the drive torque, for example adjusting a throttle valve or an injection valve. The engine control unit 13 is preferably designed in accordance with the control unit 1 shown in FIG. 1.

The vehicle transmission 9 is designed as a multi-step transmission. As such, it may provide different gear and/or transmission stages between a transmission input on the side of the drive motor and a drive output on the side of the wheel. The transmission 9 features one or more actuators 2, which adjusts/inserts one of the possible transmission stages in the transmission 9. Therefore, the vehicle transmission 9 comprises an automated manual transmission or automatic transmission or continuously variable transmission known in vehicle transmission construction. The actuator(s) 2 of the transmission 9 is/are driven, in the sense of being controlled or governed, by a transmission control unit 1, which is designed in accordance with the control unit shown in FIG. 1. The transmission control unit 1 is a part of the vehicle control system.

The vehicle control system also features the transmission control unit 1 and, if applicable, the engine control unit 13 of a superordinate vehicle control unit 11, also known as a master computer. This receives signals in terms of specifications or target values of one or more user interface(s) 12 (human machine interfaces, HMIs). In FIG. 2, an example of such a user interface 12 is presented as a known shift lever for specifying the desired transmission stage (=target value) of the transmission 9 for a vehicle operator. A different user interface would be, for example, a known accelerator for the vehicle operator for specifying the desired drive torque that should be provided by the drive motor 8 (=target value). Additional user interfaces would be, for example, one or more levers, rotary knobs, push buttons, pedals, etc. for the vehicle operator for specifying a desired braking deceleration of the vehicle or for specifying a desired shift position of a differential lock or for specifying desired settings of an air conditioning system, etc. As such, additional control units may be provided, which may be designed in accordance with the control units 1, 13 shown in FIG. 1 and which forward the specifications of the vehicle user to corresponding actuators 2.

The vehicle control unit 11 converts the signals received by the user interface(s) 12 into target values for the control units 1, 13 that is to implement the specific specification of the vehicle user. As such, the vehicle control unit 11 forwards the target values to the corresponding control units 1, 13. Thus, for example, target values that trace back to signals of the shift lever 12 are forwarded to the transmission control unit 1, or target values that trace back to signals of a drive pedal are forwarded to the engine control unit 13. That the control units 1, 13 may likewise be linked with each other is not shown. Thereby, the transmission control unit 1 may directly access the engine control unit 13, in order to, for example, temporarily reduce the drive torque provided by the drive motor 8 for a change to the transmission stage. On the other hand, the engine control unit 13 may then directly access the transmission control unit 1, in order to, for example, trigger a change to the transmission stage, which is necessary to provide the drive torque demanded by the vehicle operator.

The forwarding of signals and target values in the vehicle control system may take place, for example, through a bus system, such as a CAN bus, or a different transmission system of the vehicle control system, through a wired or wireless connection.

The control units 1, 13 are regularly synchronized with the vehicle control unit 11. Thereby, with the vehicle control unit 11, the control units 1, 13 exchange the target values attached to the respective output, whereas they update each other if there are deviations. The design of the control units 1, 13 in the sense of the invention (FIG. 1) then reduces the probability that, upon synchronization, there is an (unwanted) constantly recurring fluctuation (toggle) of the issued target values. That is, a change to the issued target value TGT takes place only if either the time period of the counter has expired or, to the extent that the time period has not yet expired, if the newly demanded REQ target value is different, thus not equal to an immediately previously set MEM target value.

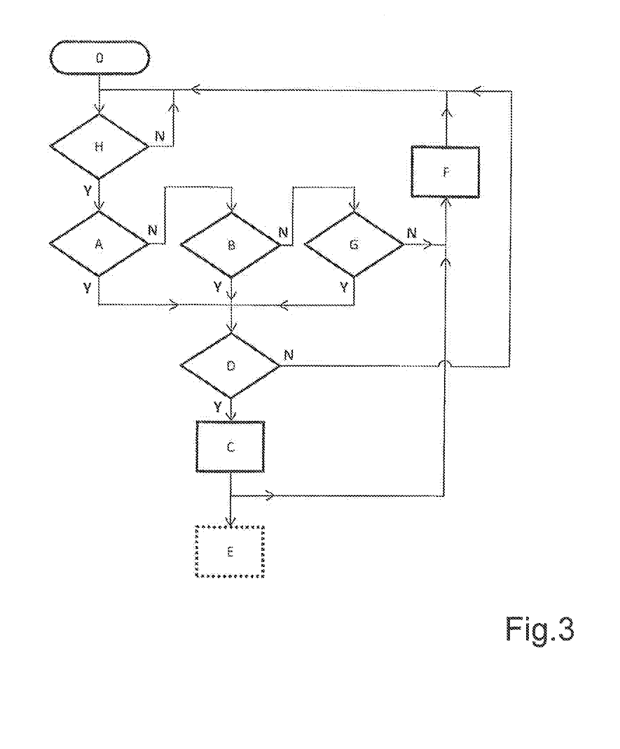

FIG. 3 shows a preferred sequence of the checks and other actions that elapse in the control unit in accordance with the invention, for example the control unit from FIG. 1 or 2. It should be noted that some of the steps shown in FIG. 3 are omitted in alternative versions, or may be exchanged with each other in the sequence. In particular, steps D and/or H and/or G may be omitted. In particular, steps A and/or B and/or D and/or G may be exchanged with each other. Upon an exchange of the steps, figuratively speaking, only the letter in the respective box in FIG. 1 is transposed. The consequence of an omission of a step will be explained below at the corresponding place.

Step 0 represents the beginning of the sequence, whereas, at this point in time, the counter 6 has not yet started and the information storage 4 is empty. This state occurs, for example, upon a full reset of the control unit. Upon the start-up of the control unit 1, the counter 6 is then restarted and passed over to step H.

In step H, there is a check of whether a change to the first target value REQ has taken place. If this is not the case (path N), step H is repeated until a change to the first target value REQ is determined. For example, this may be the case in FIG. 2 if a new target value REQ at the control unit 1 is transmitted by the vehicle control unit 11; this value differs from the previously transmitted target value. As soon as, in step H, a change to the first target value REQ is determined (path Y), there is an advancement to step A. If step H is omitted, immediately after the start-up of the control unit 1, there is an advancement to step A.

In step A, there is a check of whether the time period of the counter 6 has expired. If this is the case (path Y), there is an advancement to step D. If this is not the case (path N), there is an advancement to step B. In step B, there is a check of whether the first target value REQ does not correspond to the stored third target value MEM, thus the values REQ, MEM are not equivalent to each other. If this is the case (path Y), thus if the values REQ, MEM are not sufficiently equivalent, there is an advancement to step D. If this is not the case (path N), thus if the values REQ, MEM are sufficiently equivalent, there is an advancement to step G. If step G is omitted, instead of this, there is a direct advancement to step F. In step G, there is a check of whether the first target value REQ corresponds to an exception value EXE. If this is the case (path Y), there is an advancement to step D. If this is not the case (path N), there is an advancement to step F. In step F, the counter 6 is restarted, and there is a return to step H. The sequence then restarts.

In step D, there is a check of whether there is a deviation between the first target value REQ and the second target value, i.e. if the value REQ does not correspond to the value TGT. If this is the case (path Y), thus a deviation has been determined, there is an advancement to step C. If this is not the case (path N), thus no deviation has been determined, there is a return to step H. The sequence then restarts, but without a restart of the counter 6. If step D is omitted, instead of this, there is a direct advancement to step C.

In step C, the value of the second target value TGT is stored in the information storage 4 as the new third target value MEM, and the value of the first target value REQ is stored in the information storage 4 as the new second target value TGT. The new second target value TGT is then available in the information storage 4 for retrieval for the actuator 2 and the vehicle control unit 11. Subsequently, there is an advancement to step F, in which the counter 6 is restarted. Optionally, at step C, there may be a subsequent advancement to step E, in which the new second target value TGT, which then corresponds to the first target value REQ, is actively sent to the actuator 2 and/or the vehicle control unit 11.

The queries within the steps shown in FIG. 3 elapse in the presented sequence, preferably immediately one behind the other in the time sequence. However, some or all of the queries carried out in steps A, B, D, G, H may also elapse in parallel to save time. However, the actions that the control unit 1 carries out in relation to the storing and outputting of the target values REQ, TGT and MEM, for example the storing of the value of the first target value REQ as the new second target value TGT, always depends on the respective results of the queries, such as that shown in FIG. 3.

Modifications and variations can be made to the embodiments illustrated or described herein without departing from the scope and spirit of the invention as set forth in the appended claims.

1-12. (canceled)

13. A control unit for operating an actuator, comprising:
a reception device that receives a first target value for the actuator;
an information storage that stores a second target value and a third target value for the actuator;
an issuing device that issues the second target value to the actuator;
a counter that measures a defined time period in a Step A;
a comparing device that compares the first target value received by the reception device with the third target value stored in the information storage in a Step B;
the control unit configured such that if the time period in Step A has not expired and the first target value does not correspond to the stored third target value in Step B, then in a subsequent Step C, a value of the second target value is stored as a new third target value in the information storage and a value of the first target value is stored as a new second target value in the information storage.

14. The control unit as in claim 1, wherein the comparing device is further configured to compare in a Step D the first target value received by the reception device with the stored second target value, and step C is carried out by the control unit only if determined in Step D that the received first target value does not correspond to the stored second target value.

15. The control unit as in claim 14, wherein the issuing device is configured to issue the new second target value to the actuator in a Step E that immediately follows Step C.

16. The control unit as in claim 15, wherein the counter is configured to restart in a Step F that immediately follows Step C or Step E.

17. The control unit as in claim 13, wherein the control unit is further configured to carry out Step C is the time period measured by the counter has expired in Step A.

18. The control unit as in claim 13, wherein the control unit is further configured to determine in a step G if the first target value received by the reception device corresponds to an exception value stored in the information storage and, if so, to immediately carry out Step C.

19. The control unit as in claim 13, wherein the control unit is further configured to determine in a Step H, if the first target value received by the reception device has changed from a previously received first target value, wherein Steps A and B are not carried unless a change exists in the received first target value.

20. The control unit as in claim 13, wherein the control unit is a transmission control unit in a vehicle control system, and the first, second, and third target values correspond to shifting states of the transmission.

21. The control unit as in claim 20, wherein the transmission control unit is in communication with an actuator to bring the transmission into a shift state that corresponds to the second target value issued by the issuing device.

22. The control unit as in claim 20, wherein the control unit is in communication with a second control unit of the vehicle control system that is configured to convert a specification from a vehicle operator interface into a first target value that is received by the reception device.

23. The control unit as in claim 22, wherein the first target values and the second target values are synchronized between the transmission control unit and the second control unit.

24. The control unit as in claim 23, wherein the second control unit is connected to an electronic shift lever of the vehicle control system that allows the vehicle operator to specify a shift state for the vehicle transmission, the second control unit converting the specified shift state into a first target value for the transmission control unit.
